(19) United States
(12) Patent Application Publication
(10) Pub. No.: US 2017/0053236 A1
(43) Pub. Date: Feb. 23, 2017

(54) METHOD AND SYSTEMS FOR MANAGING SHIPPING TRANSACTIONS

(71) Applicants: John Lozito, Encinitas, CA (US); Joonyoul Choi, San Diego, CA (US)

(72) Inventors: John Lozito, Encinitas, CA (US); Joonyoul Choi, San Diego, CA (US)

(73) Assignee: Trakkx COM LLC, Encinitas, CA (US)

(21) Appl. No.: 15/243,643

(22) Filed: Aug. 22, 2016

Related U.S. Application Data
(60) Provisional application No. 62/209,594, filed on Aug. 25, 2015.
(60) Provisional application No. 62/208,503, filed on Aug. 21, 2015.
(60) Provisional application No. 62/277,701, filed on Jan. 12, 2016.
(60) Provisional application No. 62/277,709, filed on Jan. 12, 2016.

(51) Int. Cl. G06Q 10/08

(52) U.S. Cl. CPC G06Q 10/0835

(57) ABSTRACT

Systems, methods, and apparatuses are presented for connecting various parties in the freight industry to better coordinate their shipping needs while offering a much greater degree of transparency. In some embodiments, the system of the present disclosures includes a website that allows users from any of the shippers, receivers, brokers, and carriers, to login and interface with each of the other parties, as well as track the statuses of each of the shipping routes that they are involved with. The example website of the present disclosures allows a more universal and reliable medium for all members in the freight industry community to efficiently and reliably learn about the available resources from each of the different parties.

### CROSS REFERENCE TO RELATED APPLICATIONS

This application claims the benefits of U.S. Provisional Application 62/209,594, filed Aug. 25, 2015, and titled, “METHODS AND SYSTEMS FOR MANAGING SHIPPING TRANSACTIONS,” U.S. Provisional Application 62/208,503, filed Aug. 21, 2015, and titled, “METHODS AND SYSTEMS FOR SHARING PARTNERSHIP DATA IN SHIPPING TRANSACTIONS,” U.S. Provisional Application 62/277,701, filed Jan. 12, 2016, and titled, “METHODS AND SYSTEMS FOR FACILITATING SHIPPING TRANSACTIONS IN VIRTUAL DASHBOARD,” and U.S. Provisional Application 62/277,709, filed Jan. 12, 2016, and titled, “METHODS AND SYSTEMS FOR TRACKING ASSETS OF SHIPPING TRANSACTIONS IN REAL TIME,” the disclosures of which are incorporated herein by reference in their entireties and for all purposes.

This application is also related to US non provisional applications (Attorney Docket No. 1402872.00007_TRX007), titled “METHODS AND SYSTEMS FOR SHARING PARTNERSHIP DATA IN SHIPPING TRANSACTIONS,” (Attorney Docket No. 1402872.00008_TRX008), titled “METHODS AND SYSTEMS FOR FACILITATING SHIPPING TRANSACTIONS IN VIRTUAL DASHBOARD,” and (Attorney Docket No. 1402872.00009_TRX009), titled “METHODS AND SYSTEMS FOR TRACKING ASSETS OF SHIPPING TRANSACTIONS IN REAL TIME,” each of which are filed concurrently herewith, and the entire contents and substance of all of which are hereby incorporated in total by reference in their entireties and for all purposes.

### TECHNICAL FIELD

The subject matter disclosed herein generally relates to processing data. In some example embodiments, the present disclosures relate to systems and methods for managing shipping transactions.

### BACKGROUND

In shipping transactions, particularly in a shipping supply chain of the trucking industry, generally, multiple distinct parties may be involved to complete a shipping transaction. The multiple parties are generally categorized as one of a shipper, receiver, broker and carrier. Conventionally, there are many companies that can be categorized into each of these different types of parties, unlike the parcel shipping business where there are only a few major companies (e.g., FedEx, UPS, US Postal Service, etc.). Coordinating the many different types of parties, and the many entities categorized within each party, has typically been conducted manually and without complete information. In general, the trucking industry has a long-standing need for improved organization, logistics, and transparency.

### BRIEF SUMMARY

Aspects of the present disclosure are presented for a system, engine, and method for bringing together multiple parties in the trucking industry to better coordinate their shipping needs while offering a much greater degree of transparency. In some embodiments, a system for improving logistics in the trucking industry is presented. The system may include: at least one processor; at least one memory coupled to the processor; the at least one processor configured to: provide shipper user interfaces to a plurality of shipper users, wherein each of the shipper users have one or more goods available to be transported, and the shipper user interfaces are configured to facilitate generation of one or more order entries for requesting transport of said one or more goods; provide carrier user interfaces to a plurality of carrier users, wherein each of the carrier users are distinct and independent entities from one another and are each in control of one or more shipping assets configured to transport the one or more goods from at least one of the plurality of shipper users, and the carrier user interfaces are configured to view said order entries and accept said order entries to transport said one or more goods; provide receiver user interfaces to a plurality of receiver users, wherein each of the receiver users is designated to receive one or more goods from at least one of the plurality of shipper users, and the receiver user interfaces are configured to view said order entries and acceptance of said order entries by one of the carrier users; access an order entry among the one or more order entries, said order entry defining: an amount of goods supplied by one of the plurality of shipper users; said goods to be picked up and transported by one of the plurality of carrier users; and said goods to be received by one of the plurality of receiver users; transmit the order entry to at least one of the plurality of carrier users through the carrier user interfaces; and access tracking information of said goods while they are being transported to the one of the plurality of receiver users.

In some embodiments of the system, the at least one processor is further configured to provide broker user interfaces to a plurality of broker users, wherein the broker user interfaces are configured to facilitate communications between one or more shippers, one or more carriers, and one or more receivers when completing an order entry.

In some embodiments of the system, the order entry comprises a status identifier comprising one of the following statuses at every point in time until the order entry is completed: AVL (available), BKD (booked), DIS (dispatched), LDG (loading), LDD (loaded), ULD (unloading), MT (empty) and STL (settled). In some embodiments, the system is further configured to automatically change the status of the status identifier in the order entry from “available” to “booked” when a carrier user has accepted the order entry through its respective carrier user interface. In some embodiments, the system is further configured to automatically change the status of the status identifier in the order entry from “empty” to “settled” when a receiver user has received and approved shipment of the goods fulfilled in the order entry.

In some embodiments of the system, the carrier user interfaces are further configured to provide a bidding process configured to determine through a bidding competition which carrier user among the plurality of carrier users is to accept said order entry.

In some embodiments of the system, the processor is further configured to provide updated public carrier contact information about all public carriers available in a public carrier database.

In some embodiments of the system, the processor is further configured to: display the order entry first to one or more carrier user interfaces of carrier users in partnership with the shipper user; and after a delay period, display the order entry second to one or more carrier user interfaces of carrier users not in partnership with the shipper user.

In some embodiments of the system, the processor is further configured to: determine which carrier users among the plurality of carrier users are qualified to accept the order entry, based on requirement information specified in the order entry; and display the order entry in the carrier user interfaces of the carrier users who are qualified to accept the order entry.

In some embodiments, a method of a shipping management system for improving logistics in trucking industry shipping transactions is presented. The method may include: accessing, through a shipper user interface of the shipping management system, an order entry provided by the shipping user, wherein: the shipper user has one or more goods available to be transported; the shipper user interface is configured to facilitate generation of one or more order entries for requesting transport of said one or more goods; and said order entry requests transport of said one or more goods; transmitting the order entry to one or more carrier user interfaces of the shipping management system, wherein: each of the one or more carrier user interfaces provide interface to a carrier user; each of the carrier users are distinct and independent entities from one another and are each in control of one or more shipping assets configured to transport the one or more goods from at least one of the plurality of shipper users; and the carrier user interfaces are configured to view said order entries and accept said order entries to transport said one or more goods; accessing acceptance information to fulfill the order entry by a carrier user among the one or more carrier users, based on the order entry having been transmitted to the one or more carrier user interfaces; transmitting the acceptance information to a receiver user interface of the shipping management system for viewing by a receiver user designated to receive said one or more goods; and accessing tracking information of said one or more goods while they are being transported to the receiver user.

In some embodiments, a computer readable medium is presented embodying instructions that, when executed by a processor, perform operations comprising any of the actions described in the previous descriptions of the system and method.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 provides a display of an example page in the example website that allows for some of the functionality according to aspects of the present disclosure.

FIG. 3 shows a section for Load Sharing, which is one of the input fields that can be supplied in the Order Entry page in FIG. 2.

FIG. 4 provides an example of context-based autofill/autocomplete functionality that may be built into some aspects of the present disclosure.

FIG. 5 provides an example of geo-activated data population.

FIG. 6 provides an example of additional functionality for importing an order for auto filling properties, according to some embodiments.

FIG. 7 shows an example display for a live update of public carrier contact information, according to some embodiments.

FIG. 8 shows additional functionality for copy and paste features, according to some embodiments.

FIG. 9 shows one example of how an order may be interacted with among the various company types utilizing the trucking management system, according to various embodiments.

FIG. 10 shows additional options for accessing order entry information, according to some embodiments.

FIG. 11 shows an example display functionality for a manual override feature, according to some embodiments.

FIG. 12 shows one example of a methodology for conducting and facilitating a shipment request by a shipper using the trucking management system of the present disclosures, according to some embodiments.

FIG. 13 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for interfacing and managing multiple entities in shipping transactions in a shipping supply chain of the trucking industry. Generally, multiple distinct parties may be involved to complete a shipping transaction, such as a shipment of bottles of wine from a winery to a marketplace, such as a grocery store. The multiple parties are generally categorized as one of a shipper (e.g., the winery), receiver (e.g., the grocery store), broker (e.g., third party middle man helping to coordinate contacts with the parties) and carrier (e.g., truck or trucking company). Conventionally, there are many companies that can be categorized into each of these different types of parties, unlike the parcel shipping business where there are only a few major companies (e.g., FedEx, UPS, US Postal Service, etc.). For example, there are many small trucking businesses, where private contractors simply may offer their resources, e.g., their truck(s), whenever and wherever they may be available. If a shipper prefers a particular trucking service, and the trucking company is not available, the shipper must simply look to another service and hope that next company is available, and so on. Trying to coordinate the schedules and the demands of each of these different types of parties is traditionally extremely cumbersome and susceptible to error. To complicate matters, sometimes preferred partnerships are formed between various shippers, receivers, brokers, and carriers, wherein, for example, a shipper may prefer a particular carrier, while the receiver may prefer a different carrier, while a broker may prefer yet another carrier. Even more complicated are instances where various carriers may partner with each other, offering subcontracts to ship goods to various receivers halfway along the route. In these cases, the shipper may not even know that their contracted carrier has subcontracted out to another carrier, which increases risk and may even violate terms of the original contract. In general, the trucking industry has a long-standing need for improved organization, logistics, and transparency.

Aspects of the present disclosure allow for a system and an engine for bringing together these multiple parties in the trucking industry to better coordinate their shipping needs while offering a much greater degree of transparency. In some embodiments, the system of the present disclosures includes a website that allows users from any of the shippers, receivers, brokers, and carriers, to login and interface with each of the other parties, as well as track the statuses of each of the shipping routes that they are involved with. Whereas traditionally, company workers would previously rely on isolated posts in community forums, dashboards, or even physical notes on physical kiosks for learning what routes and products have been contracted out, the example platform of the present disclosures allows a more universal and reliable medium for all members in the trucking industry community to efficiently and reliably learn about the available resources from each of the different parties.

In some embodiments, the system and platform of the present disclosures may provide a visual interface through a website. The example website has an Application View and Administration View, which can be toggled by the top menu link “Switch To,” and in general provides an interface for administration privileges and normal application use. Each view has its own submenus, as Administration View can be only accessible for the users with administrator privilege to control assets, users, contacts, partnerships, alarms and application behaviors, while Application View can be accessible for the normal users who can view and interface with a number of functionalities, such as a customized order console, order and asset map views, reports, create an order entry, and manage user level contacts.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The following definitions may be used herein.

Freight management system: Main freight management website, including an administrative freight management website, installation phone utility application, freight management software services, freight management tracker hardware and software subsystems.

The freight management system of the present disclosures brings a revolutionary logistics business facilitation and modernization platform that utilizes social network software aspects for intricacy of trucking load processing and cellular communication network with GPS and monitoring sensors for product integrity information.

Freight management company: a company which signed up for the freight management website. The freight management company may have one or more roles typical in the trucking industry, described more below.

Freight management user: a user under a signed-up freight management company. The freight management company can have multiple users.

Freight management company roles follow the business entities in the trucking supply chain/logistics, which are Shipper, Receiver, Broker and Carrier. A shipper generally is defined as an entity that has goods to be moved to a receiver, such as a manufacturer of goods. A receiver generally is defined as an entity that is designated to receive goods from a shipper, such as a retail store or grocery store. A carrier generally is defined as an entity designated to pick up a shipment of goods and transport said goods to a designated location. The carrier generally is in control of shipping assets, like one or more trucks (e.g., 18 wheelers). A carrier may be a single individual who owns a truck and uses his truck to pick up and transport goods, or may be a larger organization that controls a fleet of trucks and drivers. While some companies have integrated solutions and include carrier functionality for its shipping or receiving operations, it is often the case that the shipper, carrier, and receiver are distinct and separate entities. A broker generally is defined as a coordinator to facilitate the completion of the shipping supply chain between the shipper, carrier, and receiver. A broker may be responsible for contacting various carriers to fulfill shipping and receiving needs, for example.

Freight management company can identify itself and utilize the freight management system as one or multiples of business roles where the freight management website provides unprecedented visibility to the freight management companies.

Partnership: freight management companies can establish partnerships amongst themselves to benefit each other in the business practice to facilitate their own operations.

Contact: There are three types of contacts—public (from e.g., FMCSA database), private (e.g., Freight management company maintained from public contacts) and my company public (e.g., company's public list compilation if it has multiple locations).

Asset: A freight management tracker attached trailer or tractor of the truck.

Order: A freight management order is a work order or shipping/delivery load which encompasses all the necessary information to move goods from A to B including pickups, deliveries, carrier, tracking, requirement, sharing, equipment, driver, finance information, product integrity information such as temperature, speed and more.

Order may have a number of different statuses, expressed in codes. Order has eight status including AVL (available), BKD (booked), DIS (dispatched), LDG (loading), LDD (loaded), ULD (unloading), MT (empty) and STL (settled). Other statuses readily apparent to those with ordinary skill in the art are also possible, and embodiments are not so limited.

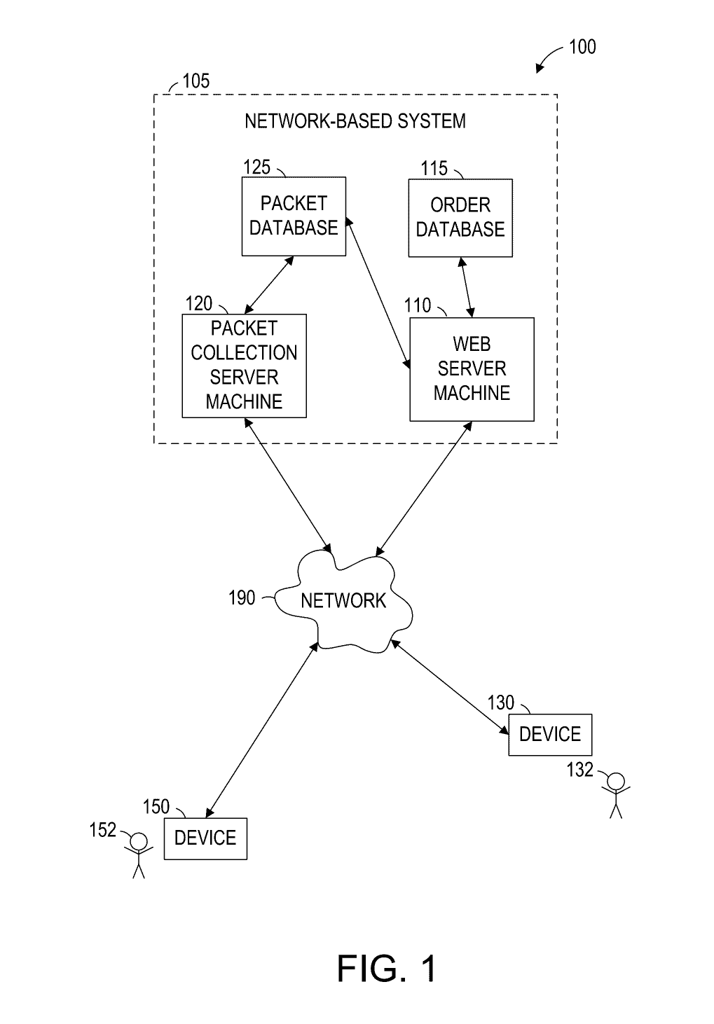

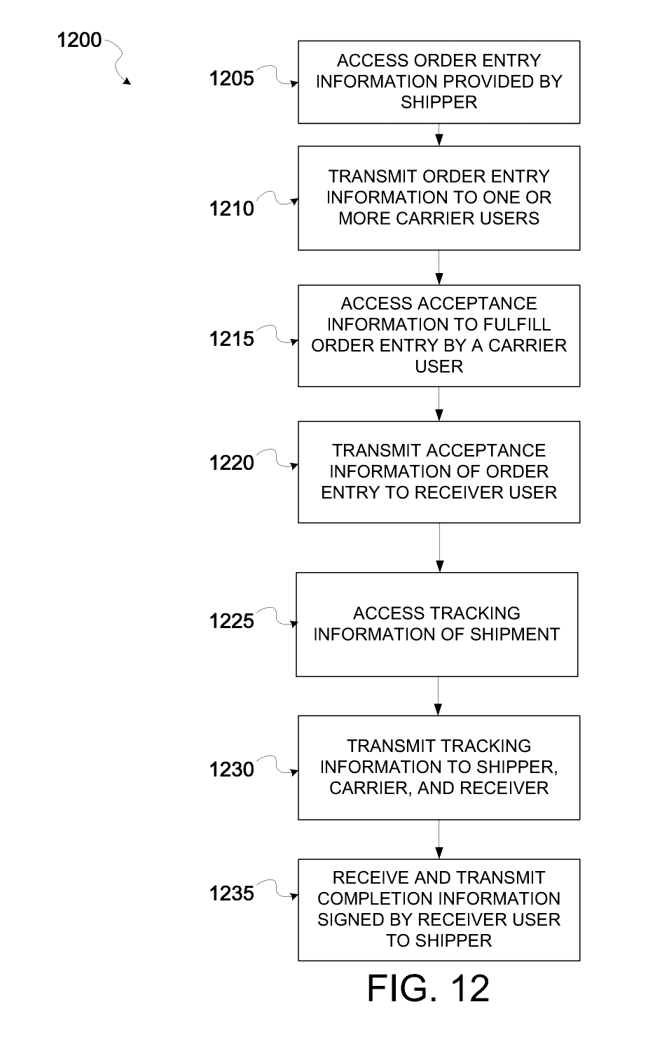

Referring to FIG. 1, a network diagram illustrating an example network environment 100 suitable for performing aspects of the present disclosure is shown, according to some example embodiments. The example network environment 100 includes a web server machine 110, an order database 115, a packet collection server machine 120, a packet database 125, a first device 130 for a first user 132, and a second device 150 for a second user 152, wherein the server machines 110 and 120 are communicatively coupled to the devices 130 and 150 via a network 190. In some embodiments, either or both of the web server machine 110 and packet collection server machine 120 may form all or part of a network-based system 105 (e.g., a cloud-based server system configured to provide one or more services to the first and second devices 130 and 150). The web server machine 110, the packet collection server machine 120, the first device 130, and the second device 150 may each be implemented in a computer system, in whole or in part, as described below with respect to FIG. 12. Through this example configuration of the network-based system 105, aspects of the present disclosure may be configured to enable either of the devices 130 or 150 to track information derived from the other device 150 or 130, as well as track any web interface devices, such as if device 130 or 150 operates as a web interface device. In other words, the devices 130 and 150 may be configured to interface with the system of the present disclosures, as well as with other devices, through both a web-based interface and through an app-based interface.

Also shown in FIG. 1 are the first user 132 and the second user 152. One or both of the first and second users 132 and 152 may be a human user, a machine user (e.g., a computer configured by a software program to interact with the first device 130), or any suitable combination thereof (e.g., a human assisted by a machine or a machine supervised by a human). The first user 132 may be associated with the first device 130 and may be a user of the first device 130. For example, the first device 130 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the first user 132. Likewise, the second user 152 may be associated with the second device 150. As an example, the second device 150 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the second user 152. Other devices, not shown, may also be configured to interface with the network-based server 105 similar to devices 130 and 150, and embodiments are not so limited. For example, the first device 130 may be operated by a shipper, the second device 150 may be operated by a carrier, a third device may be operated by a broker, and a fourth device may be operated by a receiver, all of which may be configured to transmit and receive information about a shipping transaction from each other device.

Any of the machines 110 and 120, databases 115 and 125, or first or second devices 130 or 150 shown in FIG. 1 may be implemented in a general-purpose computer modified (e.g., configured or programmed) by software (e.g., one or more software modules) to be a special-purpose computer to perform one or more of the functions described herein for that machine 110 or 120, database 115 or 125, or first or second device 130 or 150. For example, a computer system able to implement any one or more of the methodologies described herein is discussed below with respect to any of the descriptions in the following figures. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines 110 and 120, databases 115 and 125, and devices 130 and 150. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

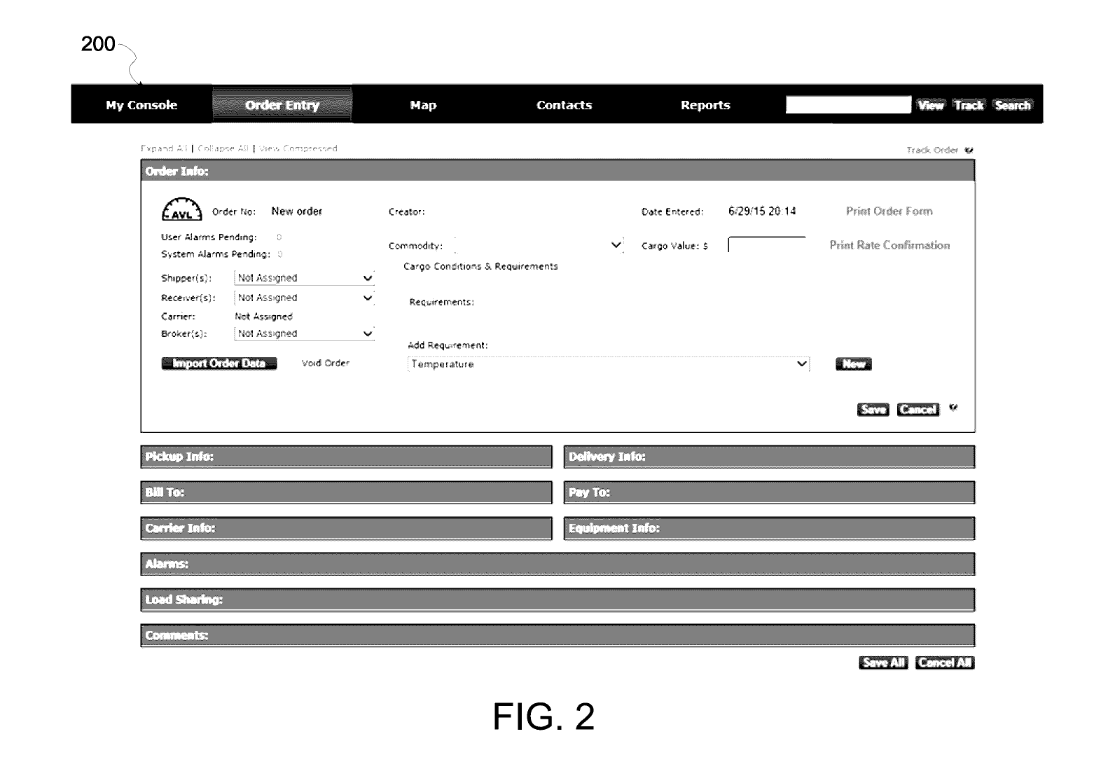

Referring to FIG. 2, illustration 200 provides a display of an example page in the example website that allows for some of the functionality according to aspects of the present disclosure. Here, an Order Entry tab is shown. The Order Entry may be used for creating a new order and this page has expandable sections to set many elements of the order, including delivery good type, requirements, pickups, deliveries, account bill to, account pay to, carrier info, asset equipment and driver info, alarms, load sharing, and system or user generated comments, as shown in illustration 200. Each of these input fields specified by a user may be recorded and stored into a database of the website and cross-referenced and matched to other users that can meet the needs specified by the user in the Order Entry. For example, the network-based system 105 may be configured to receive any and all order entries supplied with information from a display like in illustration 200, and may cross reference information supplied by other trucking management companies who have subscribed to the trucking management system and website. Whereas conventionally, a company wishing to send a shipment of goods may have very little visibility as to what carrier has the capability and availability to handle the desired shipment for example, the system of the present disclosures provides much greater visibility and in some cases may automatically suggest which entities can satisfy the needs of the shipping order.

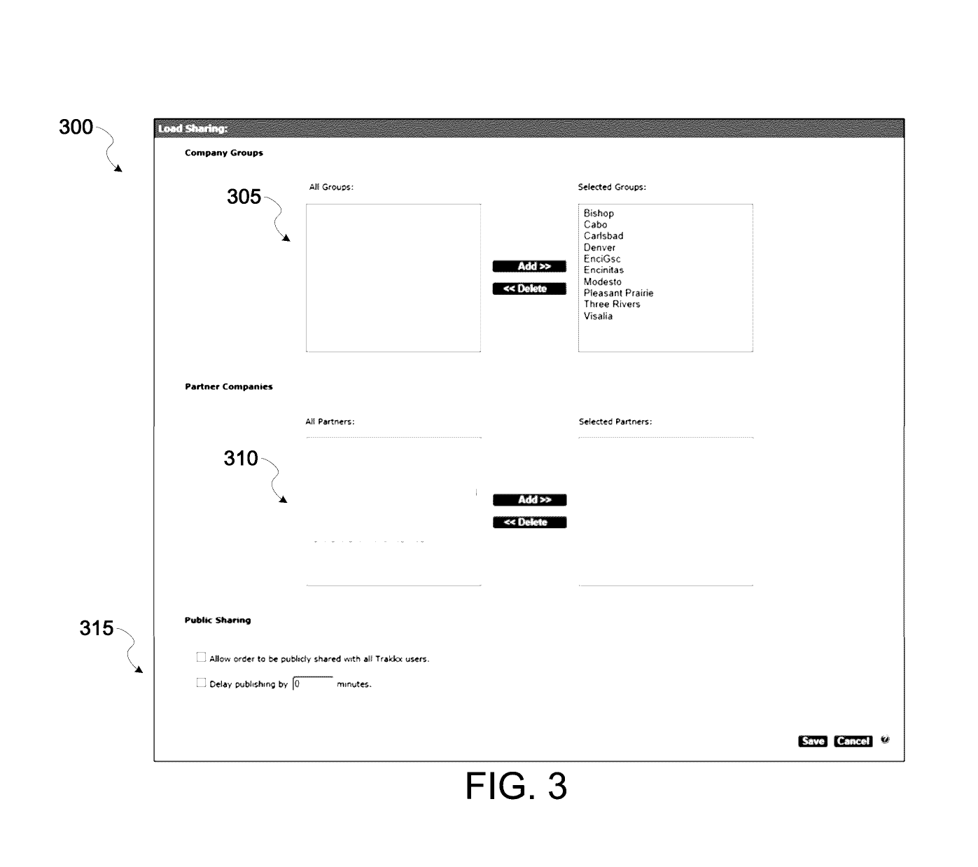

Referring to FIG. 3, illustration 300 shows a section for Load Sharing, which is one of the input fields that can be supplied in the Order Entry page in illustration 200. Load Sharing is for sharing orders among groups, partners and to make public with conditions configured in the Administration View. Additionally, order-level sharing can be defined here to include or exclude the order in creation for those available candidates. Groups inclusion 305 can limit internal company-level user group sharing while partners inclusion 310 controls sharing with already approved partners. Once shared, the order can be viewed in the order consoles of involved trucking management companies through built in propagation logic of the website according to aspects of the present disclosure. The concept of partnerships and their interactions will be described in more detail in a related disclosure, namely, US non-provisional application (Attorney Docket No. 1402872.00007), which is incorporated herein by reference.

Order-level public sharing 315 is a part of load sharing where the order initiator or creator can set whether and when the order can be available to other general trucking management users outside of partnerships once the order is complete and ready (e.g., order AVL status, meaning that pickups and deliveries are set and account bill to info is determined). In this way, the order initiator may have functionality for providing preferential treatment for some carriers over others when requesting help to move a shipment. Defining partnerships may also be another way for providing preferential treatment, which is discussed in more detailed in related US non-provisional application (Attorney Docket No. 1402872.00007).

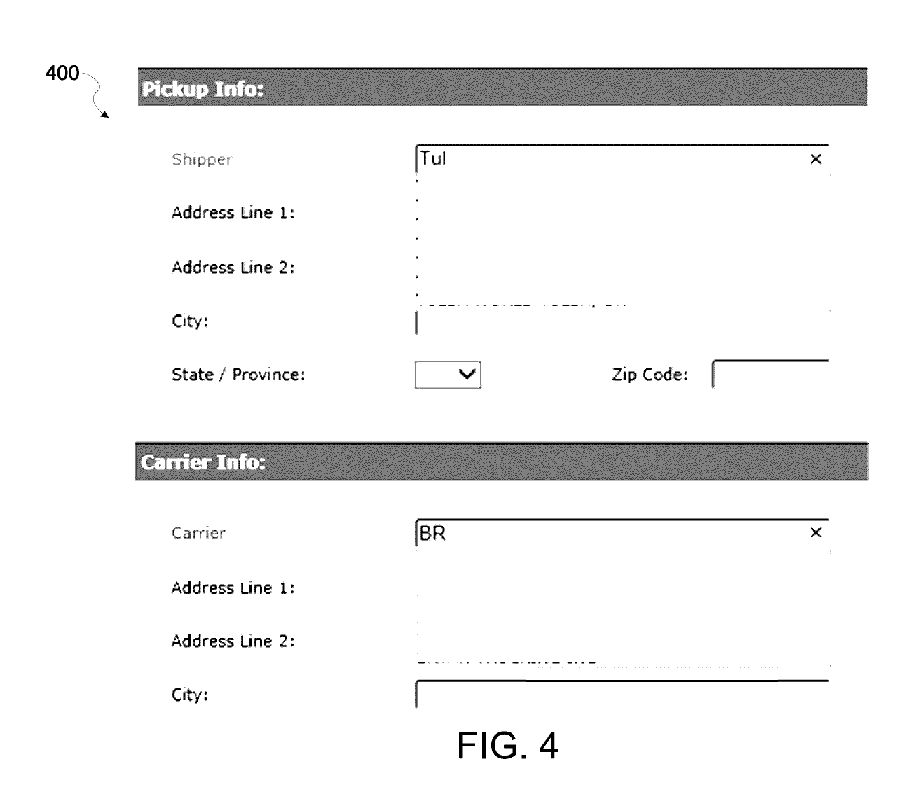

Referring to FIG. 4, illustration 400 provides an example of context-based autofill/autocomplete functionality that may be built into some aspects of the present disclosure. Throughout the order entry, all the data inputs have context aware data verification and built-in data autofill/autocomplete. For example, if the user is trying to set a pickup or carrier, available pickup or carrier candidates are automatically listed in the name field based on user's private contact list and its role type. Also, the user can select one from a public list by clicking the “Shipper” or “Carrier” link next to the name field, for example. Once the desired entity is selected from either a private or public option, all the relevant data fields are automatically filled in. This information may be supplied by known entries in a database of the network-based system 105, such as databases 115 or 125. The same principle applies to delivery, bill-to and pay-to selecting. Another context awareness example is that when the user assigns a carrier, then all the available assets belonging to the assigned carrier are automatically populated as possible candidates.

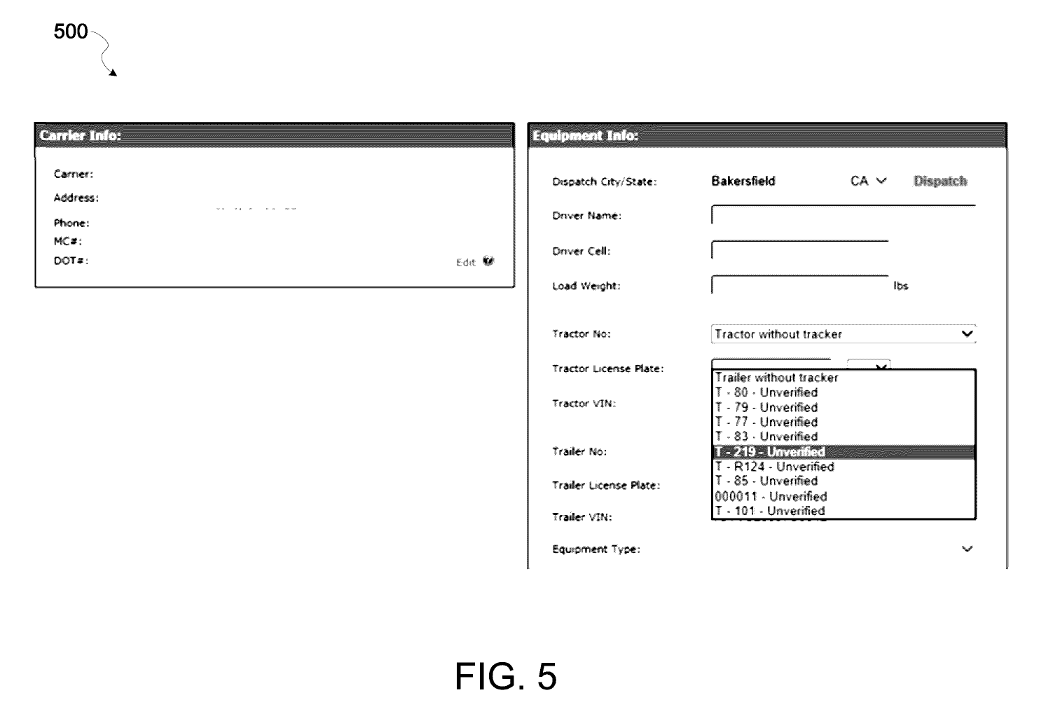

Referring to FIG. 5, illustration 500 provides an example of geo-activated data population. When assigning an asset, e.g., a truck owned by carrier, to dispatch, the dispatching location may be automatically set based on current GPS data of the selected asset. Once dispatched, the Trucking management tracking service starts to monitor geo locations along with product integration data such as temperature, door open/close status, speed, etc., and utilizes location data to automatically advance the order status such as “loading” and “loaded” for pickups and “unloading” and “empty” for deliveries. In some embodiments, geofencing size, which determines the proximity of the target location, can be configured through a shipper's or receiver's setup options, such as the My company contact setup in the Administration View. Otherwise, a default size radius may be used.

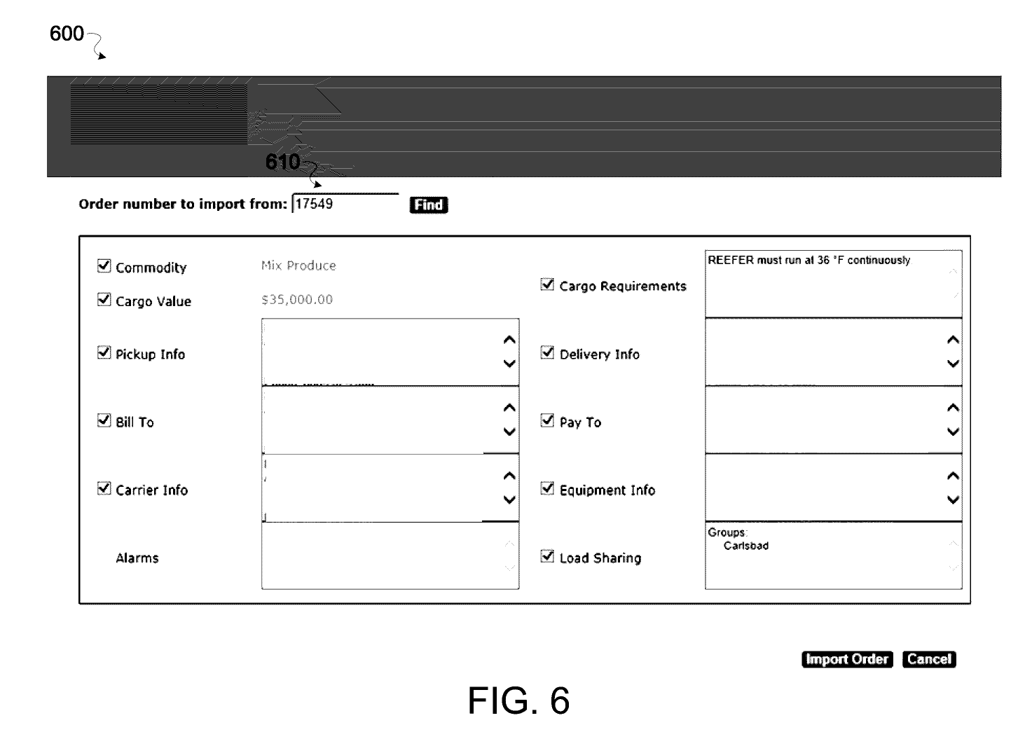

Referring to FIG. 6, illustration 600 provides an example of additional functionality for importing an order for auto filling properties, according to some embodiments. The order initiator can enter in a previous order number in the field 610 that may allow for automatic filling of the order information from that previous order number. The “Import Order” button greatly simplifies the process of re-creating repetitive order elements by additionally offering a template of an existing order with an inclusion/exclusion option. For example, the user may check or uncheck different boxes, as shown, to include or exclude various information from the previous order, for the present order.

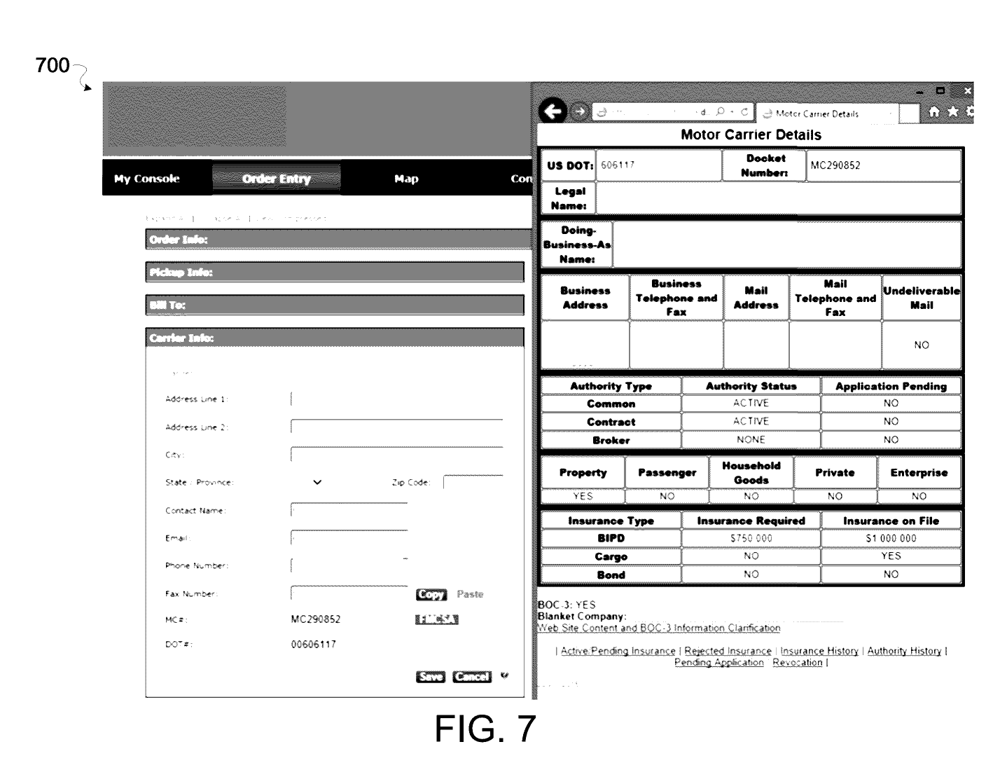

Referring to FIG. 7, illustration 700 shows an example display for a live update of public carrier contact information, according to some embodiments. As previously mentioned, obtaining relevant information in the trucking industry can be quite cumbersome and inefficient. The website according to aspects of the present disclosure allows a user to see updates to public information in a live format. In some embodiments, the Trucking management system updates its public carrier contact database regularly from the FMCSA (Federal Motor Carrier Safety Administration) to make the information current. However, the entire database may be quite large (about 250K entries) and information can change frequently (e.g., a few thousand changes per day). Therefore, the trucking management system may use live update functionality of the data whenever the information is being used or requested. For example, in some embodiments, Order Entry's carrier section has a “FMCSA” lookup button for a given MC number, enabling the access to up-to-date information of FMCSA data as well as updating the Trucking management database behind the scenes. In other cases, the trucking management system of the present disclosures may automatically update the information from the FMCSA database at the beginning of each business day, by automatically logging in to a subscribed account and refreshing all data obtained from the database. In this case, a button to request a refresh or update of the database information for a particular entity would not be necessary, as the data is automatically refreshed at the beginning of each business day.

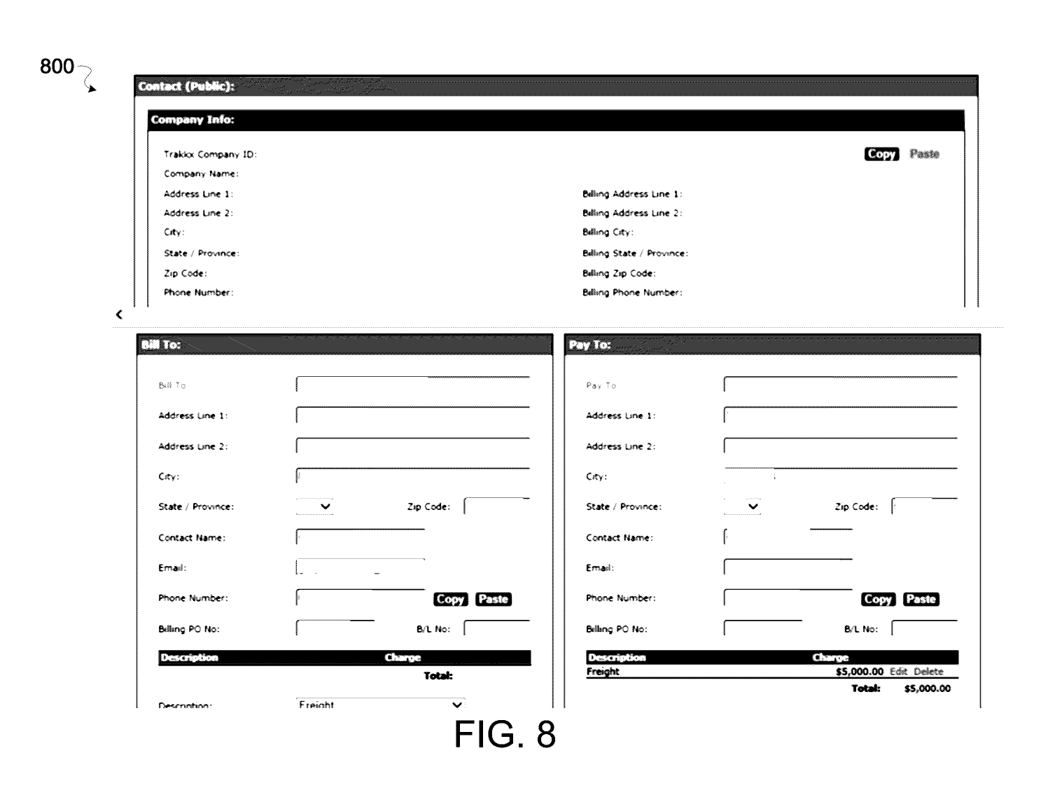

Referring to FIG. 8, illustration 800 shows additional functionality for copy and paste features, according to some embodiments. Here, copy and paste buttons are provided to easily move around relevant information between the Order Entry's sections and from referencing a Contact's detail page. For example, the user can copy the data by using the copy button in the “Carrier Info” section and the paste button in the “Pay To” section. Alternatively, the user may utilize the copy button from the referencing public contact (accessed by the link next to each section's name field) and the paste button inside the target section, so that the data can be pasted into it. This is another convenience feature to reduce any repetitive user input effort/error and time to create an order.

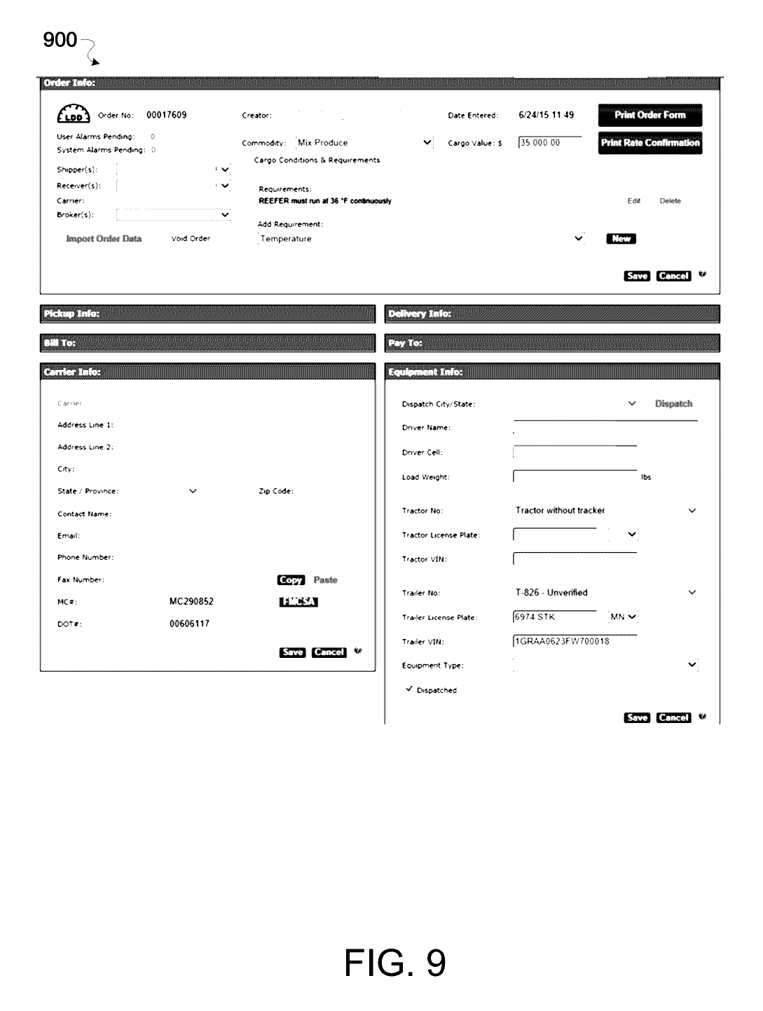

Referring to FIG. 9, illustration 900 shows one example of how an order may be interacted with among the various company types utilizing the trucking management system, according to various embodiments. That is, the trucking management system is unique as it provides a logistics-industry focused social network and collaboration platform for trucking management users to maximize business transparency and efficiency. The Order Entry allows for an actual creation process of this sharable and collaborative business target. Any users under signed up trucking management companies with various roles (i.e., Shipper, Receiver, Broker or Carrier) can participate in the order lifecycle process to achieve their business objectives. A typical example can be: a shipper (e.g., a wine company) signs in and initiates an order by using Order Entry to set pickup and delivery date/time and locations along with other details, like offering fund and the moving goods' various properties (e.g., regulated temperature, weight of goods, special handling properties) and requirements (e.g., Order status becomes “Available”). Then, a broker partnered with the shipper can see this order in its own console and take it, meaning that a broker user can access the Order Entry page of that order and may assign this load to his/her favorite carrier (e.g., Order status becomes “Booked”). Now, a carrier can see this order and assign its asset and dispatch it (e.g., Order status becomes “Dispatched”). A receiver can sign in and verify the information any time, too. Note that there can be many other scenarios of work flow, for example, a shipper can be a broker at the same time as it initiates an order and assign a carrier by itself, or a broker can be a carrier at the same time as it assigns its own asset to the order and dispatches it. Another scenario could be that a broker does not pick a specific carrier but any carriers from broker's partnership list can bid for business by assigning themselves. Furthermore, there could be cases of the broker being the initiator of the process by assigning a shipper or a trucking management company can be passively involved in an order by being assigned as a “Pay To” entity due to some business reasons. And so on. The trucking management Order Page is engineered to handle the intricacy of logistics dynamics utilizing business heuristics. One of the built-in features to support this business intelligence is to selectively enable/disable order modification based on the status of a given order and which role the user is playing in the process. Illustration 900 shows one example of an order entry first being created by the shipper, but then being handled by a carrier at “loaded” status for the order.

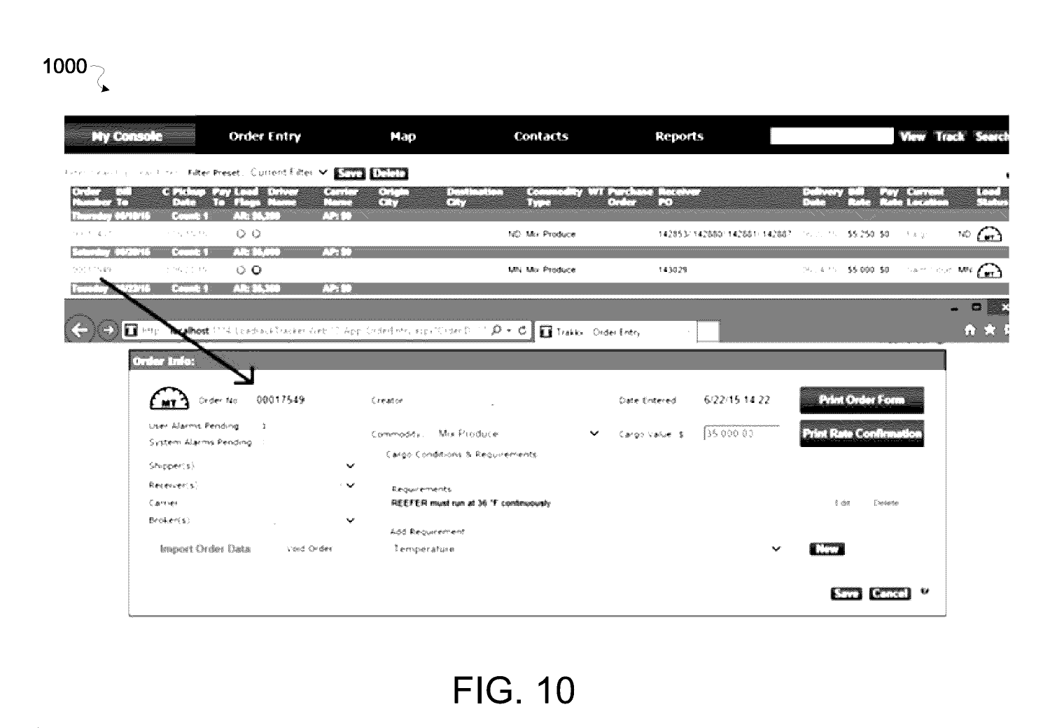

Referring to FIG. 10, illustration 1000 shows additional options for accessing order entry information, according to some embodiments. Here, when accessed from the console's context sensitive links (not directed accessed by the “Order Entry” menu), the Order Entry page acts as a detailed view but allows user role and order status based modification.

Once trucking management real-time tracking is started (details of which may be described in additional disclosures, such as US non-provisional application 1402872.00009), the Track Order page can be accessed from the Order Entry page (or the console's context sensitive location links), which gives the user complete visibility of order location and progress along with other product integrity data. Therefore, any user with a given/playing role can check his/her order's up to date tracking information.

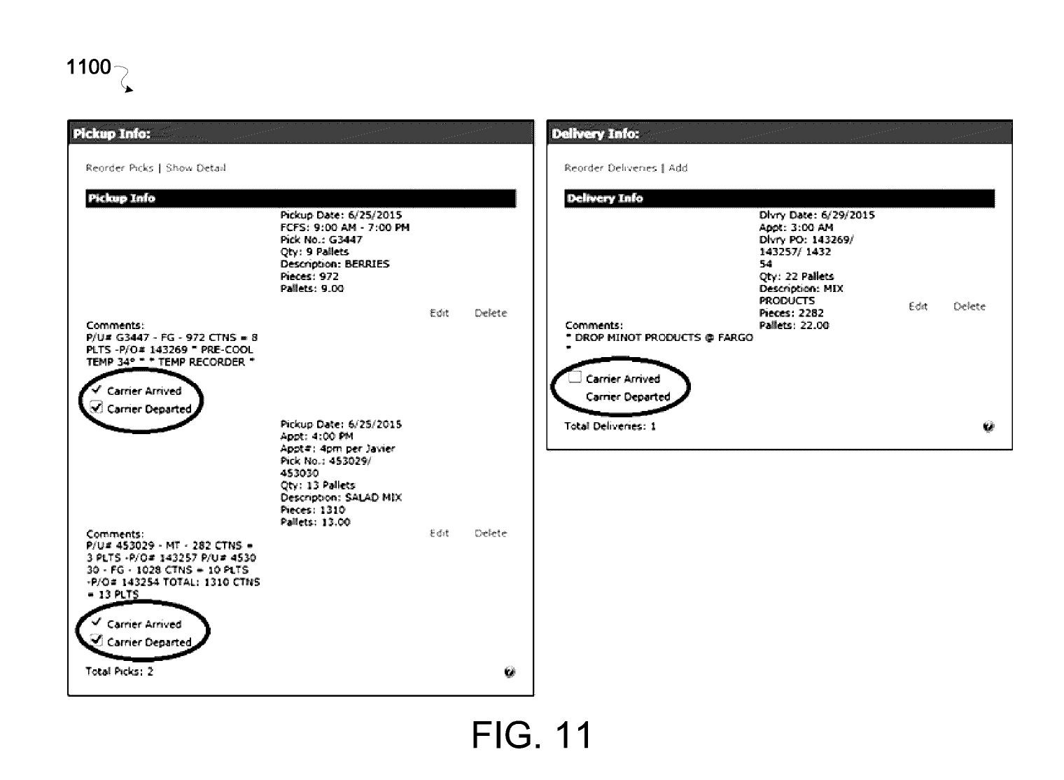

Referring to FIG. 11, illustration 1100 shows an example display for a manual override feature. While order progressing after tracking start is automatic with the Trucking management tracker enabled asset, there are cases that manual intervention is necessary, such as truck failure, re-dispatching, etc. The Trucking management Order Entry page enables the user with proper privileges to manually override an order status or track the order, in some embodiments. Moreover, the user, if necessary, can manually reverse the order progress all the way back to “Available” status from any given status by following strict order status progression/regression rule. For example, “Loaded” status will become “Unloading” if the “Carrier Arrived” checkbox of delivery info is checked or “Loaded” status can go back to “Loading” status if “Carrier Departed” checkbox of pickup info is unchecked. Note that, whenever order status changes, all the necessary order modification rule is dynamically enforced.

In some embodiments, additional functionality for integrating third party software for the order entry information is also available. For example, the Trucking management order creation may expose Web APIs, allowing bridge architecture so that any third party can integrate order creation/data sharing processes with the Trucking management system. For example, QuickBooks accounting system is already integrated and this accounting bridge generates orders automatically into the Trucking management with pre-defined order properties along with accounting data.

Referring to FIG. 12, flowchart 1200 provides one example of a methodology for conducting and facilitating a shipment request by a shipper using the trucking management system of the present disclosures, according to some embodiments. Examples of the interfaces used to fulfill these procedures may be described in the previous figures, such as FIGS. 2-11. Additional variants of this typical example are also described in FIG. 9, and other scenarios are contemplated by the present disclosures apparent to those with ordinary skill in the art. The trucking management system may utilize a system like the network-based system 105 to facilitate these procedures described herein.

In this example, starting at block 1205, the trucking management system, as implemented by the network-based system 105, may access order entry information provided by a shipper. This information may include a variety of pertinent facets, including types of goods, time and location for starting and ending the route, special requirements for handling the goods, and fees for conducting the shipping route. Other types of example information are described in the previous figures.

At block 1210, the order entry information may be accepted by the trucking management system and then disseminated or transmitted to one or more carrier users for them to view. In some cases, a broker may be responsible for first transmitting this information to specific carriers, and in general may be responsible for facilitating the process. In other cases, a broker is not used, and the trucking management system may directly facilitate the communications between the shipper and multiple carriers. In some cases, the information is first transmitted by the trucking management system to specific carriers engaged in a partnership with the shipper, while in other cases the order entry information is disseminated simultaneously to multiple carriers at a public level.

At block 1215, the trucking management system may be configured to access acceptance information from or by a carrier user that signifies acceptance to fulfill the order entry by the shipper. The acceptance information may come from a carrier who accepts the order entry on a first come, first served basis, or through other means of deciding who can fulfill the order. For example, an auction or bidding process may take place and be facilitated by the trucking management system. The bidding process may allow the lowest bidder to accept the order entry. In other cases, certain preferred carriers arranged in a partnership may have first access to the order entry. In other cases, specifically-named carriers may have first access to the order entry. At block 1220, this acceptance information may be transmitted to a receiver who is intended to receive the shipment provided in the order entry. In addition, in some embodiments, the acceptance information may also be transmitted to the shipper and a broker, if one is used. This may occur all through the trucking management system, rather than hand carried or physically communicated through other means. This provides a readily available and transparent system for all parties involved in the complex trucking and shipping industries.

At block 1225, the trucking management system may then be configured to track the shipment by the designated carrier. Further details of real-time tracking are provided in US non-provisional application (Attorney Docket No. 1402872.00009), which is again incorporated herein by reference. At block 1230, the trucking management system may be configured to transmit the tracking information to the multiple parties involved. This information may be readily available to the shipper, receiver, and the carrier, as well as the broker if one is used. Again, all of these features may be provided through the same trucking management shipping interfaces, provided a centralized platform to manage the entire shipping process.

At block 1235, once the shipping route is complete, the carrier may receive acceptance of the shipment by the receiver. The trucking management system may then receive and transmit the completion information signed by the receiver user to the shipper, carrier company, and the broker, if one is used.

In general, the broker may facilitate any and all of these processes. In some cases, the broker may be a dual user, such as the shipper may also act as the broker to facilitate coordination with the carrier and the receiver. In other cases, the carrier or the receiver may also act as the broker and perform similar coordination functions. In addition, the example methodology of illustration 1200 may be initiated by a broker rather than the shipper itself, and since the broker may be the carrier or the receiver, the carrier or the receiver may actually be the company that initiates the process. The trucking management system of the present disclosures is configured to handle all manners of logistics by these four general entities, to robustly take into consideration the multiple permutations of business relationships already established in the trucking industry.

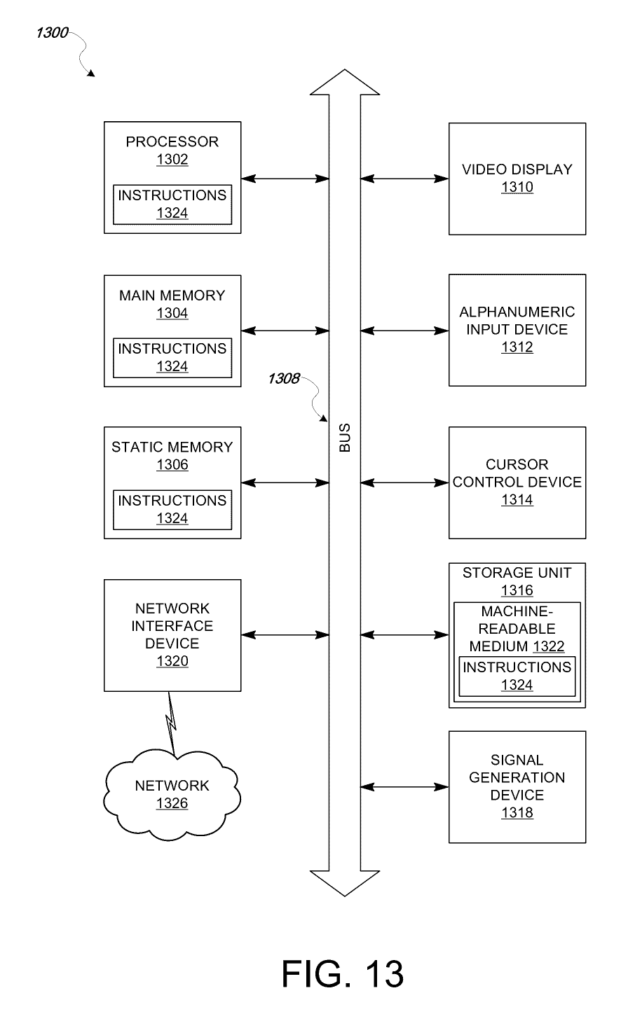

Referring to FIG. 13, the block diagram illustrates components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 13 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be connected (e.g., networked) to other machines. In a networked deployment, the machine 1300 may operate in the capacity of a server machine 110 or a client machine in a server-client network environment, or as a peer machine in a distributed (e.g., peer-to-peer) network environment. The machine 1300 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1324, sequentially or otherwise, that specify actions to be taken by that machine. Further, while only a single machine 1300 is illustrated, the term “machine” shall also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a video display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, a signal generation device 1318 (e.g., a sound card, an amplifier, a speaker, a headphone jack, or any suitable combination thereof), and a network interface device 1320.

The storage unit 1316 includes the machine-readable medium 1322 (e.g., a tangible and non-transitory machine-readable storage medium) on which are stored the instructions 1324 embodying any one or more of the methodologies or functions described herein, including, for example, any of the descriptions of FIGS. 1-12. The instructions 1324 may also reside, completely or at least partially, within the main memory 1304, within the processor 1302 (e.g., within the processor's cache memory), or both, before or during execution thereof by the machine 1300. The instructions 1324 may also reside in the static memory 1306.

Accordingly, the main memory 1304 and the processor 1302 may be considered machine-readable media 1322 (e.g., tangible and non-transitory machine-readable media). The instructions 1324 may be transmitted or received over a network 1326 via the network interface device 1320. For example, the network interface device 1320 may communicate the instructions 1324 using any one or more transfer protocols (e.g., HTTP). The machine 1300 may also represent example means for performing any of the functions described herein, including the processes described in FIGS. 1-12.

In some example embodiments, the machine 1300 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1322 able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database 115, or associated caches and servers) able to store instructions 1324. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device 130 or 150, as well as cloud-based storage systems or storage networks that include multiple storage apparatus or devices 130 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1322 is non-transitory in that it does not embody a propagating signal. However, labeling the tangible machine-readable medium 1322 as “non-transitory” should not be construed to mean that the medium is incapable of movement; the medium should be considered as being transportable from one physical location to another. Additionally, since the machine-readable medium 1322 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1322 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1302 or a group of processors 1302) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1302 or other programmable processor 1302. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1308) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1302 that are temporarily configured (e.g., by software) or permanently configured to perform the relevant operations. Whether temporarily or permanently configured, such processors 1302 may constitute processor-implemented modules that operate to perform one or more operations or functions described herein. As used herein, “processor-implemented module” refers to a hardware module implemented using one or more processors 1302.

Similarly, the methods described herein may be at least partially processor-implemented, a processor 1302 being an example of hardware. For example, at least some of the operations of a method may be performed by one or more processors 1302 or processor-implemented modules. As used herein, “processor-implemented module” refers to a hardware module in which the hardware includes one or more processors 1302. Moreover, the one or more processors 1302 may also operate to support performance of the relevant operations in a “cloud computing” environment or as a “software as a service” (SaaS). For example, at least some of the operations may be performed by a group of computers (as examples of machines 1300 including processors 1302), with these operations being accessible via a network 1326 (e.g., the Internet) and via one or more appropriate interfaces (e.g., an API).

The performance of certain operations may be distributed among the one or more processors 1302, not only residing within a single machine 1300, but deployed across a number of machines 1300. In some example embodiments, the one or more processors 1302 or processor-implemented modules may be located in a single geographic location (e.g., within a home environment, an office environment, or a server farm). In other example embodiments, the one or more processors 1302 or processor-implemented modules may be distributed across number of geographic locations.

Unless specifically stated otherwise, discussions herein using words such as “processing,” “computing,” “calculating,” “determining,” “presenting,” “displaying,” or the like may refer to actions or processes of a machine 1300 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A system for improving logistics in freight industry shipping transactions, the system comprising:
at least one processor;
at least one memory coupled to the processor;
the at least one processor configured to:
provide shipper user interfaces to a plurality of shipper users, wherein each of the shipper users have one or more goods available to be transported, and the shipper user interfaces are configured to facilitate generation of one or more order entries for requesting transport of said one or more goods;
provide carrier user interfaces to a plurality of carrier users, wherein each of the carrier users are distinct and independent entities from one another and are each in control of one or more shipping assets configured to transport the one or more goods from at least one of the plurality of shipper users, and the carrier user interfaces are configured to view said order entries and accept said order entries to transport said one or more goods;
provide receiver user interfaces to a plurality of receiver users, wherein each of the receiver users is designated to receive one or more goods from at least one of the plurality of shipper users, and the receiver user interfaces are configured to view said order entries and acceptance of said order entries by one of the carrier users;
access an order entry among the one or more order entries, said order entry defining:
an amount of goods supplied by one of the plurality of shipper users;
said goods to be picked up and transported by one of the plurality of carrier users; and
said goods to be received by one of the plurality of receiver users;
transmit the order entry to at least one of the plurality of carrier users through the carrier user interfaces; and
access tracking information of said goods while they are being transported to the one of the plurality of receiver users.

2. The system of claim 1, wherein the at least one processor is further configured to provide broker user interfaces to a plurality of broker users, wherein the broker user interfaces are configured to facilitate communications between one or more shippers, one or more carriers, and one or more receivers when completing an order entry.

3. The system of claim 1, wherein the order entry comprises a status identifier comprising one of the following statuses at every point in time until the order entry is completed: AVL (available), BKD (booked), DIS (dispatched), LDG (loading), LDD (loaded), ULD (unloading), MT (empty) and STL (settled).

4. The system of claim 3, wherein the system is further configured to automatically change the status of the status identifier in the order entry from “available” to “booked” when a carrier user has accepted the order entry through its respective carrier user interface.

5. The system of claim 3, wherein the system is further configured to automatically change the status of the status identifier in the order entry from “empty” to “settled” when a receiver user has received and approved shipment of the goods fulfilled in the order entry.

6. The system of claim 1, wherein the carrier user interfaces are further configured to provide a bidding process configured to determine through a bidding competition which carrier user among the plurality of carrier users is to accept said order entry.

7. The system of claim 1, wherein the processor is further configured to provide updated public carrier contact information about all public carriers available in a public carrier database.

8. The system of claim 1, wherein the processor is further configured to:
display the order entry first to one or more carrier user interfaces of carrier users in partnership with the shipper user; and
after a delay period, display the order entry second to one or more carrier user interfaces of carrier users not in partnership with the shipper user.

9. The system of claim 1, wherein the processor is further configured to:
determine which carrier users among the plurality of carrier users are qualified to accept the order entry, based on requirement information specified in the order entry; and
display the order entry in the carrier user interfaces of the carrier users who are qualified to accept the order entry.

10. A method of a shipping management system for improving logistics in freight industry shipping transactions, the method comprising:
accessing, through a shipper user interface of the shipping management system, an order entry provided by the shipping user, wherein:
the shipper user has one or more goods available to be transported;
the shipper user interface is configured to facilitate generation of one or more order entries for requesting transport of said one or more goods; and
said order entry requests transport of said one or more goods;
transmitting the order entry to one or more carrier user interfaces of the shipping management system, wherein:
each of the one or more carrier user interfaces provide interface to a carrier user;
each of the carrier users are distinct and independent entities from one another and are each in control of one or more shipping assets configured to transport the one or more goods from at least one of the plurality of shipper users; and
the carrier user interfaces are configured to view said order entries and accept said order entries to transport said one or more goods;
accessing acceptance information to fulfill the order entry by a carrier user among the one or more carrier users, based on the order entry having been transmitted to the one or more carrier user interfaces;
transmitting the acceptance information to a receiver user interface of the shipping management system for viewing by a receiver user designated to receive said one or more goods; and
accessing tracking information of said one or more goods while they are being transported to the receiver user.

11. The method of claim 10, further comprising facilitating communication of the order entry through a broker user interface configured to facilitate communications between one or more shippers, one or more carriers, and one or more receivers for completing the order entry.

12. The method of claim 10, wherein the order entry comprises a status identifier comprising one of the following statuses at every point in time until the order entry is completed: AVL (available), BKD (booked), DIS (dispatched), LDG (loading), LDD (loaded), ULD (unloading), MT (empty) and STL (settled).

13. The method of claim 12, further comprising automatically changing the status of the status identifier in the order entry from “available” to “booked” when a carrier user has accepted the order entry through its respective carrier user interface.

14. The method of claim 12, further comprising automatically changing the status of the status identifier in the order entry from “empty” to “settled” when a receiver user has received and approved shipment of the goods fulfilled in the order entry.

15. The method of claim 10, further comprising providing a bidding process through the one or more carrier user interfaces, the bidding process configured to determine through a bidding competition which carrier user among the plurality of carrier users is to accept said order entry.

16. The method of claim 10, further comprising providing updated public carrier contact information about all public carriers available in a public carrier database.

17. The method of claim 10, further comprising:
displaying the order entry first to one or more carrier user interfaces of carrier users in partnership with the shipper user; and
after a delay period, displaying the order entry second to one or more carrier user interfaces of carrier users not in partnership with the shipper user.

18. The method of claim 10, further comprising:
determining, by the shipping management system, which carrier users among the plurality of carrier users are qualified to accept the order entry, based on requirement information specified in the order entry; and
displaying the order entry in the carrier user interfaces of the carrier users who are qualified to accept the order entry.

19. A computer-readable medium having no transitory signals and embodying instructions that, when executed by a processor, perform operations comprising:
accessing, through a shipper user interface of a shipping management system, an order entry provided by the shipping user, wherein:
the shipper user has one or more goods available to be transported;
the shipper user interface is configured to facilitate generation of one or more order entries for requesting transport of said one or more goods; and
said order entry requests transport of said one or more goods;
transmitting the order entry to one or more carrier user interfaces of the shipping management system, wherein:
each of the one or more carrier user interfaces provide interface to a carrier user;
each of the carrier users are distinct and independent entities from one another and are each in control of one or more shipping assets configured to transport the one or more goods from at least one of the plurality of shipper users; and
the carrier user interfaces are configured to view said order entries and accept said order entries to transport said one or more goods;
accessing acceptance information to fulfill the order entry by a carrier user among the one or more carrier users, based on the order entry having been transmitted to the one or more carrier user interfaces;
transmitting the acceptance information to a receiver user interface of the shipping management system for viewing by a receiver user designated to receive said one or more goods; and
accessing tracking information of said one or more goods while they are being transported to the receiver user.

20. The computer readable medium of claim 19, wherein the operations further comprise facilitating communication of the order entry through a broker user interface configured to facilitate communications between one or more shippers, one or more carriers, and one or more receivers for completing the order entry.
